(19) United States
(12) Patent Application Publication
(10) Pub. No.: US 2014/0289551 A1
(43) Pub. Date: Sep. 25, 2014

(54) FAULT MANAGEMENT IN AN IT INFRASTRUCTURE

(71) Applicant: Hewlett-Packard Development Company, L.P., Houston, TX (US)

(72) Inventor: Sandhya Balakrishnan, Bangalore (IN)

(73) Assignee: Hewlett-Packard Development Company, L.P., Houston, TX (US)

(21) Appl. No.: 13/897,002

(22) Filed: May 17, 2013

(30) Foreign Application Priority Data
Mar. 20, 2013 (IN) 1214/CHE/2013

(51) Int. Cl. G06F 11/07

(52) U.S. Cl. CPC G06F 11/0793
USPC 714/2

(57) ABSTRACT

Provided is a method of fault management in an IT infrastructure. An IT resource is monitored to identify a likelihood of occurrence of a fault related to the IT resource. Upon said identification, a determination is made whether a solution is available to prevent the occurrence of the fault related to the IT resource. If a solution is available, the solution is applied to the IT resource prior to the occurrence of the fault related to the IT resource.

CLAIM FOR PRIORITY

The present application claims priority under 35 U.S.C. 119 (a)-(d) to Indian Patent application number 1214/CHE/2013, filed on Mar. 20, 2013, which is incorporated by reference herein in its entirety.

### BACKGROUND

Information technology (IT) infrastructures of organizations have grown in complexity over the last few decades. Innovative technologies such as virtualization and cloud computing have added new kinds of IT resources (for example, virtual machines) to many existent IT infrastructures comprising of software and hardware resources. Needless to say, it has become quite a challenge for IT personnel to monitor, manage and control problems in the new environment, and to ensure that system performance and availability of resources is not compromised with the growth in the infrastructure.

### BRIEF DESCRIPTION OF THE DRAWINGS

For a better understanding of the solution, embodiments will now be described, purely by way of example, with reference to the accompanying drawings, in which:

FIG. 1 is a diagram of an information technology infrastructure in which a fault management system may be implemented, according to an example.

FIG. 2 illustrates a method of fault management in an IT infrastructure, according to an example.

FIG. 3 illustrates a Graphical User Interface (GUI) element representing availability of a solution applicable to an IT resource, according to an example.

### DETAILED DESCRIPTION OF THE INVENTION

As mentioned earlier, information technology infrastructure of organizations have grown in diversity and complexity over the years due to developments in technology. There are a variety of new computing options (for example, a virtual server) available now which were not present earlier. Further, the advent of virtualization technology has led to a virtual sprawl with thousand of instances being brought up quickly, adding to the complexity in datacenters. This has made the task of IT personnel who are responsible for managing the IT infrastructure of their enterprises even more difficult.

Typically, an IT administrator relies on monitoring solutions for detection, reporting and isolation of problems in an IT resource. These monitoring solutions although useful do not help IT personnel move beyond the usual cycle of detect-and-repair. In other words, a repair action is pursued only after the detection of a problem. There's no mechanism to pre-empt the occurrence of a problem and application of a solution before the problem actually occurs in an IT resource. Further, there's also no mechanism to contain a problem so that it doesn't resurface again in the future. Needless to say, unavailability of these options could be trying for IT personnel who end up constantly monitoring a number of IT resources for performance, availability and security.

Proposed is a method that provides for a proactive fault management approach in an IT infrastructure. The solution monitors an IT resource to identify the likelihood of occurrence of a fault related to the IT resource. Upon said identification, it determines whether a solution is available to prevent the occurrence of the fault related to the IT resource, and if a solution is available, it applies the solution to the IT resource prior to the occurrence of the fault in the IT resource. In other words, proposed method “immunizes” an IT resource against a future fault. Proposed method also provides an option to apply the solution to an analogous IT resource in the IT infrastructure. In other words, “immunization” could be extended and applied to sibling IT resources in an IT infrastructure.

The term “information technology (IT) infrastructure” may be defined as a combined set of hardware, software, networks, facilities, etc. in order to develop, test, deliver, monitor, control or support IT services. Also, as used herein, the term “resource” refers to software and hardware components that are accessible locally and/or over a network. Some non-limiting examples of resources may include servers, printers, routers, data centers, application programs, file utilities, disk drives, and the like.

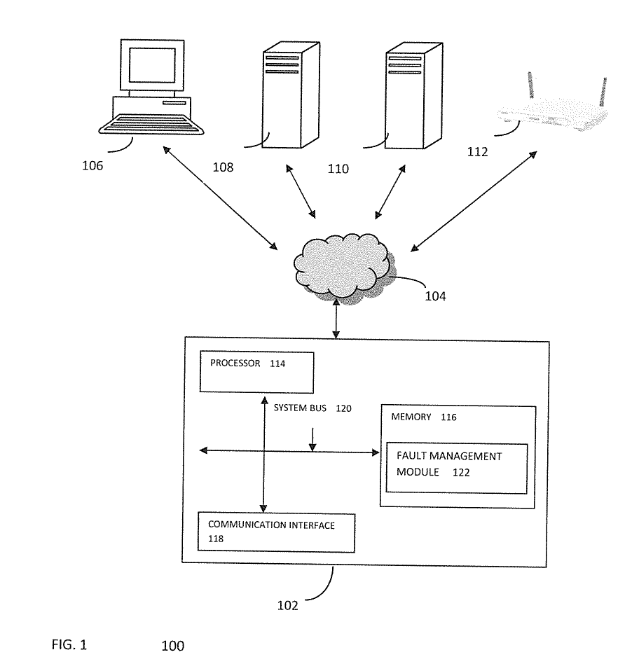

FIG. 1 is a diagram of an information technology infrastructure 100 in which a fault management system may be implemented, according to an example. Information technology infrastructure 100 includes server 102, network 104, and information technology (IT) resources 106, 108, 110 and 112. Various components of system 100 i.e. server 102 and information technology (IT) resources 106, 108, 110 and 112 could be operationally connected over network 104, which may be wired or wireless. Network 104 may be a public network such as the Internet, or a private network such as an intranet. It would be appreciated that the components depicted in FIG. 1 are for the purpose of illustration only and the actual components (including their number) may vary depending on the computing architecture deployed for implementation of the present invention.

Computer server 102 is a computer or computer application (machine executable instructions) that provides services to other computers or computer applications. Computer server 102 may include a processor 114, a memory 116, and a communication interface 118. The components of computer server may be coupled together through a system bus 120. Processor 110 may include any type of processor, microprocessor, or processing logic that interprets and executes instructions. Memory 116 may include a random access memory (RAM) or another type of dynamic storage device that may store information and instructions non-transitorily for execution by processor.

In an implementation, memory 116 includes fault management module 122. Fault management module 122 monitors an IT resource to identify a likelihood of occurrence of a fault related to the IT resource; determines, upon said identification, whether a solution is available to prevent the occurrence of the fault related to the IT resource; and if the solution is available, applies the solution to the IT resource prior to the occurrence of the fault related to the IT resource. In another implementation, fault management module 122 may be hosted on an IT resource itself such as information technology (IT) resources 106, 108, 110 and 112 of FIG. 1. Fault management module 122 can also be integrated with existing monitoring solutions.

Communication interface may include any transceiver-like mechanism that enables computer server 118 to communicate with other devices and/or systems via a communication link. Communication interface may be a software program, a hard ware, a firmware, or any combination thereof. Communication interface may use a variety of communication technologies to enable communication between computer server and another computing device. To provide a few non-limiting examples, communication interface may be an Ethernet card, a modem, an integrated services digital network (“ISDN”) card, etc.

In an implementation, computer server 104 may host a Configuration Management Database (CMDB) (not illustrated in FIG. 1). Configuration Management Database describes configuration items (CIs) in an information technology infrastructure and the relationships between them. A configuration item basically means a component of an IT infrastructure (for example, information technology resources 106, 108, 110 and 112) or an item associated with an infrastructure. A CI may include, for example, servers, computer systems, computer applications, routers, etc.

The relationships between configuration items (CIs) may be created automatically through a discovery process or inserted manually. Considering that an IT environment can be very large, potentially containing thousands of CIs, the CIs and relationships together represent a model of the components of an IT environment in which a business functions. Computer server 120 gathers various details for each information technology resource 106, 108, 110 and 112 and stores them in the Configuration Management Database (CMDB). The CMDB stores these relationships and handles the infrastructure data collected and updated, for instance, by a discovery process. The discovery process enables collection of data about an IT environment by discovering the IT infrastructure resources and their interdependencies (relationships). The process discovers resources such as applications, databases, network devices, different types of servers, and so on. Each discovered IT component is stored in the configuration management database where it may be represented as a managed configuration item (CI).

Information technology (IT) resources 106, 108, 110 and 112 are coupled to computers server 102 over network 104. As mentioned earlier, information technology resources refer to software and hardware components that are accessible locally and/or over a network. Some non-limiting examples of resources may include servers, printers, routers, data centers, application programs, file utilities, disk drives, and the like. In an implementation, information technology resources include computer system 106, server 108, server 110, and router 112 (as depicted in FIG. 1).

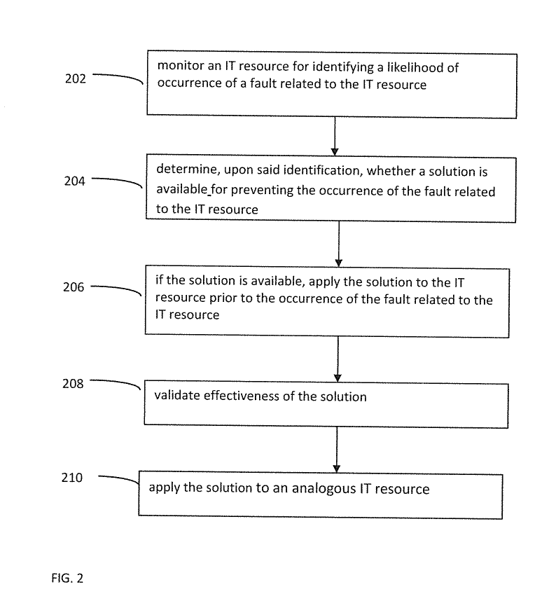

FIG. 2 illustrates a method of fault management in an IT infrastructure, according to an example. At block 202, an IT resource of an IT infrastructure is monitored for identifying a likelihood of occurrence of a fault related to the IT resource. In an implementation, as a precursor to the monitoring, IT resources present in an IT infrastructure may be federated into a Configuration Management Database (CMDB) on a computer server. As mentioned earlier, a discovery process may be used to collect data about an IT environment by discovering the IT infrastructure resources and their interdependencies (relationships). The process discovers resources such as applications, databases, network devices, different types of servers, etc. Each IT resource is discovered and stored in the configuration management database where it is represented as a managed configuration item (CI).

Once information regarding the presence of an IT resource in an IT infrastructure is available, the IT resource is pro-actively monitored to determine whether there's a possibility of occurrence of a fault related to the IT resource. Depending on the type of IT resource (for example, a server or router) an appropriate monitoring tool could be used for this purpose. A monitoring tool may monitor various parameters of an IT resource related to, for instance, its performance, availability, security, and other like factors. A monitoring tool may depend on a policy interface to define monitoring and for sending notifications in case of a violation. In an instance, a monitoring tool is used to identify a likelihood of occurrence of a fault related to an IT resource based on analysis of various performance factors related to the functioning of the IT resource. In other words, “health” of an IT resource is monitored to identify the possibility of occurrence a problem with the IT resource. Aforesaid problem could be resource failure, resource non-availability, reduced performance of the resource, etc. In an implementation, an event notification may be provided to a user identifying a likelihood of occurrence of a fault related to the IT resource.

At block 204, if it is identified that there's a likelihood of occurrence of a fault related to the IT resource, a determination is made whether a solution is available for preventing or controlling the occurrence of the fault related to the IT resource. In other words, a search is performed to determine if there could be a solution to prevent the occurrence of the fault whose likelihood of occurrence was determined earlier. A search may be performed within the IT infrastructure of which the IT resource is a member or even outside of the IT infrastructure. Accordingly, a solution could be available within the IT infrastructure of which the IT resource is a part or external to the IT infrastructure.

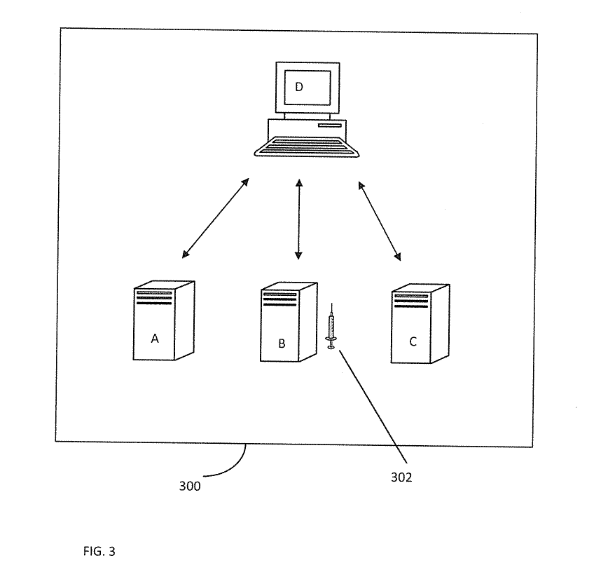

In case a solution to prevent the occurrence of the fault in the IT resource is available, it may be displayed to a user (for example, an IT personnel) for selection. The availability of a solution (which could be applied to an IT resource) may be indicated by a Graphical User Interface (GUI) element. This is illustrated in FIG. 3.

FIG. 3 illustrates an information technology infrastructure in the form a Graphical User Interface (GUI) 300, according to an example. Various components of information technology infrastructure 300, which includes computer servers “A”, “B” and “C” and computer system “D”, are represented as images in the GUI 300. The availability of a solution (which could be applied to an IT resource) is indicated by a Graphical User Interface (GUI) element (for example, an icon, an image, etc.). In the present case, an image of a “syringe” 302 next to computer server “B” is used to indicate that a solution to prevent the occurrence of a fault in computer server “B” is available. In the event there is a plurality of solutions available, all solutions may be displayed to a user for making a selection. In such case, a distinct GUI element may be displayed for each solution.

It may be noted that solution to a fault related to an IT resource may vary depending on the type of IT resource. For instance, solution to a problem that may occur in a computer server could be different to a solution for a fault in a router. In other words, a solution would depend on the technology domain and could be of different types. To provide an example, let's consider a scenario where a Virtualized SQL/Oracle server is experiencing severe performance issues. In this case, a possible cause could be that an administrator might have disabled the ballooning mechanism in order to stop VMkernel from reclaiming memory from that specific virtual machine (VM). In the event, possible solutions could be (a) Do not disable Balloon driver since disabling ballooning could trigger costlier reclamation methods like hypervisor swapping which may worsen the VM performance during a contention; (b) Use resource allocation unit settings to avoid reclamation, and (c) Be careful when specifying memory parameters as severe over commitment could lead to performance issues and a reduced consolidation rate.

To provide another example, let's consider another domain in which memory considerations need to be made for virtualizing enterprise applications. In this case, an automated tool could check whether the balloon driver, if available, is always enabled. If the balloon driver is not installed than a solution could include generating a warning for the user and/or automating the balloon driver installation process.

Thus the above examples illustrate that solution to a fault related to an IT resource may vary depending on the type of IT resource. Further, there could be different types of solutions. For example, a solution could be an automated script which users can immediately apply, a pseudo-code which the end-user can leverage in his environment, or plain instructions which the end-user can refer to for execution. It may be mentioned here that application of a solution for a fault which is yet to occur in an IT resource is akin to applying a “vaccine” to “immunize” the IT resource against the occurrence of the problem.

Referring back to FIG. 2, at block 206, if a solution is available for preventing the occurrence of a fault related to the IT resource, the solution is applied to the IT resource prior to the occurrence of the fault related to the IT resource. A solution may be automatically applied upon identification of a likelihood of occurrence of a fault related to the IT resource, or it may be applied manually by a user. In the event there is a plurality of solutions available, a user may apply one or multiple solutions to the IT resource prior to the occurrence of the fault.

At block 208, a determination is made whether the solution(s) applied to the IT resource for preventing or controlling the occurrence of a fault related to the IT resource was successful or not. In other words, whether the solution was useful in preventing or controlling a potential problem related to the IT resource. Said differently, a validation of the applied solution(s) is carried out. In one instance, a validation may be performed by monitoring the IT resource over a period of time for occurrence of the problem. If a fault doesn't occur in a time span, it means the solution that was applied to the IT resource was successful. The time period, of course, can be modified by a user to monitor an IT resource in a given time range.

At block 210, if a solution applied to an IT resource for preventing or controlling the occurrence of a fault is successfully validated, same solution may be applied to an analogous (or “sibling”) IT resource whether present within or external to the IT infrastructure. For example, if a solution applied to a computer server has been successful in preventing a problem, an equivalent solution could be applied to another computer server of similar characteristics. In this manner, the solution could be applied to all analogous IT resources present within or external to the IT infrastructure to prevent the occurrence of the fault.

On the other hand, if a solution applied to an IT resource for preventing or controlling the occurrence of a fault fails or is unsuccessful during validation, the solution may be modified to address the cause of failure. In an instance, the modified solution may be applied to the IT resource again to prevent the occurrence of the fault. In this manner, improvements may be made to find a successful solution. Once successful, a modified solution may be applied to an analogous IT resource whether present within or external to the IT infrastructure.

In an implementation, a successfully validated solution or a successfully validated modified solution is stored, for example, but not necessarily, within an IT infrastructure, for application to a new analogous IT resource(s) which may be added or introduced to the IT infrastructure in the future.

In an implementation, the results of a validation performed on a solution are displayed to a user. In other words, whether a solution was successfully or unsuccessfully validated is displayed to a user in the form a Graphical User Interface (GUI) element. For instance, referring to the illustration in FIG. 3, the GUI element “syringe” 304 may be represented in different colors representing the success or failure of a validation. If a solution is successfully validated it may be presented in “green” color. On the other hand if the validation has failed, the color may be changed to “red”. Thus, in this manner, a user can have a visual presentation of availability and success of a solution applicable to an IT resource (“File system” 302 in this case).

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in the illustrated figures are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of fault management in an IT infrastructure, comprising:
monitoring an IT resource for identifying a likelihood of occurrence of a fault related to the IT resource;
determining, upon said identification, whether a solution is available for preventing the occurrence of the fault related to the IT resource; and
if the solution is available, applying the solution to the IT resource prior to the occurrence of the fault related to the IT resource.

2. The method of claim 1, further comprising applying the solution to an analogous IT resource in the IT infrastructure.

3. The method of claim 1, further comprising applying the solution to all analogous IT resources in the IT infrastructure.

4. The method of claim 1, further comprising validating the solution by evaluating its effectiveness in preventing the occurrence of the fault related to the IT resource over a time frame.

5. The method of claim 4, further comprising displaying a result of the validation to a user.

6. The method of claim 4, further comprising modifying the solution if the validation is unsuccessful.

7. The method of claim 6, further comprising applying the modified solution to the IT resource.

8. The method of claim 6, further comprising applying the modified solution to an analogous IT resource.

9. A system for fault management in an IT infrastructure, comprising:
a memory; and
a fault management module stored in the memory to:
monitor an IT resource to identify a likelihood of occurrence of a fault related to the IT resource;
determine, upon said identification, whether a solution is available to prevent the occurrence of the fault related to the IT resource; and
if the solution is available, apply the solution to the IT resource prior to the occurrence of the fault related to the IT resource.

10. The system of claim 9, wherein the solution is available on an IT resource within the IT infrastructure.

11. The system of claim 9, wherein the solution is available external to the IT infrastructure.

12. The system of claim 9, wherein the solution is displayed to a user for making a selection.

13. The system of claim 9, wherein the solution is applied to an existing analogous IT resource in the IT infrastructure.

14. The system of claim 9, wherein the solution is applied to future analogous IT resource added to the IT infrastructure.

15. A non-transitory processor readable medium, the non-transitory processor readable medium comprising machine executable instructions, the machine executable instructions when executed by a processor causes the processor to:
monitor an IT resource in an IT infrastructure to identify a likelihood of occurrence of a fault related to the IT resource;
determine, upon said identification, whether a solution is available to prevent the occurrence of the fault related to the IT resource; and
if the solution is available, apply the solution to the IT resource prior to the occurrence of the fault.
